(19) United States
(12) Patent Application Publication
(10) Pub. No.: US 2010/0153480 A1
(43) Pub. Date: Jun. 17, 2010

(54) SYSTEM AND METHOD FOR DISTRIBUTION OF MEDIA ASSETS FROM MEDIA DELIVERY UNIT TO HANDHELD MEDIA PLAYER

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/334,463

(22) Filed: Dec. 13, 2008

(51) Int. Cl. G06F 17/00; G06F 15/16

(52) U.S. Cl. 709/201

(57) ABSTRACT

A media delivery system is disclosed. The system comprises a media delivery unit, a handheld media player and a remote control device. According to one embodiment, the media delivery unit may include a high fidelity (HiFi) audio system with an added data compression unit and a file storage system. The handheld media player may be a MP3 player. The HiFi system and the MP3 player are connectable through a high speed connector such as a FIREWIRE (IEEE 1394 type of connection). The invention is characterized by that an audio file is compressed and is transferred to the connected MP3 player while the audio file in the high fidelity format is being played by the HiFi system. The remote control device is used to select a mode of data transfer between the HiFi system and the MP3 player. The modes may include transferring data from one device to another or transferring the data in a bi-directional manner to synchronize two media asset databases.

### CROSS-REFERENCE TO RELATED APPLICATIONS

Not applicable.

### BACKGROUND

1. Field of Invention

This invention relates to a media delivery system, specifically to system and method for distribution of media assets from a media delivery unit to a handheld media player.

2. Description of Prior Art

Due to the increasing capacity and capability of personal computers, it has become popular to use a personal computer connected to the Internet as a repository for media assets such as for example, songs and multi-media clips. The media assets are typically compressed to a desired format such as MP3 (Motion Picture Expert's Group Layer 3) for songs for digital distribution through the Internet. Handheld media players are used to download media assets from the personal computer. Examples of handheld media players are the iPod from Apple, Inc. of Cupertino, Calif., the Zen from Creative Technology Ltd, Singapore and the Zune from Microsoft Inc of Redmond, Wash. The media assets are typically acquired with media management applications, such as iTunes software, which is a product from Apple Inc. The handheld media players have gained popularity due to its capability to store large number of media assets in a device, which can be put into a user's pocket when he or she is moving around.

Downloading media assets from the personal computer to a handheld media player may be carried out via a FIREWIRE (IEEE 1394 type of connection). Although the penetration rate of the personal computer has been increased substantially over recent years, in particularly in developed countries, there are many people in developing countries who could still not afford to have a personal computer.

Prior art for transferring media assets among various portable devices has been disclosed. US patent publication 2004/0224638 by Fadell et al. teaches a media player system with wired and wireless communication capabilities to other media devices. The media assets may be shared among the connected media devices. McCain in U.S. Pat. No. 7,373,110 teaches a personal communication system comprising portable communication devices for audio file sharing.

Significant amount of media assets, in particularly, audio assets are still delivered to users through more a conventional means such as through a home high fidelity (HiFi) audio system. Recently, a media delivery system comprising an audio system and a handheld media player connectable through a connector such as the IEEE 1394 compliant one has been taught by Hobson et al in US patent publication 2007/0230723. The audio system is used to read out audio files from the connected media player and to deliver to a user through the high quality sound system. Ko et al in US patent publication 2007/0169115 further teach a method of using a portable multi media player arranged to store digital media files to wirelessly access and/or control a media server configured to stream digital media data to a media unit, wherein the portable media player and the server are connected wirelessly.

All above mentioned prior art publications, however, do not teach a method for transferring a media asset in a desired format from a home audio system, which is typically used to deliver a high fidelity audio asset, to a handheld media player. Therefore, it is desirable to have a system and method to accomplish such a desirable functionality. With such a system, more people who are not the users of the personal computers can also access large number of media assets through using the home HiFi audio system and the handheld media players.

### SUMMARY OF THE INVENTION

In an exemplary embodiment, a media delivery system includes a home high fidelity (HiFi) audio system and a MP3 player. The HiFi system and the MP3 player are connectable through a high-speed connector such as a FIREWIRE (IEEE 1394 type of connection). The HiFi system may further comprise a conventional HiFi audio system with an added data compression unit and a file storage system. The operation of the exemplary media distribution system may be controlled by a remote control device.

According to one embodiment, an audio data file associated with a song or a music clip is compressed to a desired format such as MP3 while the asset in the high fidelity format is being delivered (played) by the HiFi system. The compressed data file may be transferred to the MP3 player, which is connected to the HiFi system through the FIREWIRE. The operation of the transferring may be triggered by the remote control device.

According to another embodiment, the compressed audio data may be stored in the file storage system of the HiFi system when the asset is being played. The number of audio files in the compressed format will be increased in the file storage system when more files are played by the HiFi system. The stored audio files may be transferred to the MP3 player when the two devices are connected.

According to yet another embodiment, audio files stored in the MP3 player may be transferred to the file storage system of the HiFi system and be delivered to users by the system. The audio file databases in the HiFi system and the MP3 player may be synchronized.

The remote control device may be used to receive a user's instruction and to manage the data transfer between the HiFi system and the MP3 player.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a media delivery system comprising a media delivery unit, a handheld media player and a remote control device.

FIG. 2 is a schematic diagram of a home audio delivery system including a HiFi audio system and a handheld media player. They are connectable through a high-speed connector.

FIG. 3 is a schematic functional block of a HiFi audio system according to one embodiment of the present invention.

FIG. 4 is a schematic functional block of a MP3 player according to one embodiment of the present invention.

FIG. 5 shows a flow diagram of the operation that an audio asset in the high fidelity format is being played by the HiFi system while the asset is compressed and transferred to the MP3 player.

FIG. 6 shows a flow diagram of the operation that compressed media assets stored in the file storage system of the HiFi system are transferred to the MP3 player when they are connected.

FIG. 7 shows a flow diagram of the operation that compressed media assets are transferred from the MP3 player to the file storage system of the HiFi system.

FIG. 8 shows a flow diagram of the operation that compressed media assets are transferred in between the HiFi system and the MP3 player and two media file databases are synchronized.

FIG. 9 shows a schematic diagram of a remote control device according to one embodiment of the present invention.

FIG. 10 shows a schematic diagram of the remote control device is used to select a mode of the data transfer between the HiFi system and the MP3 player when they are connected.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

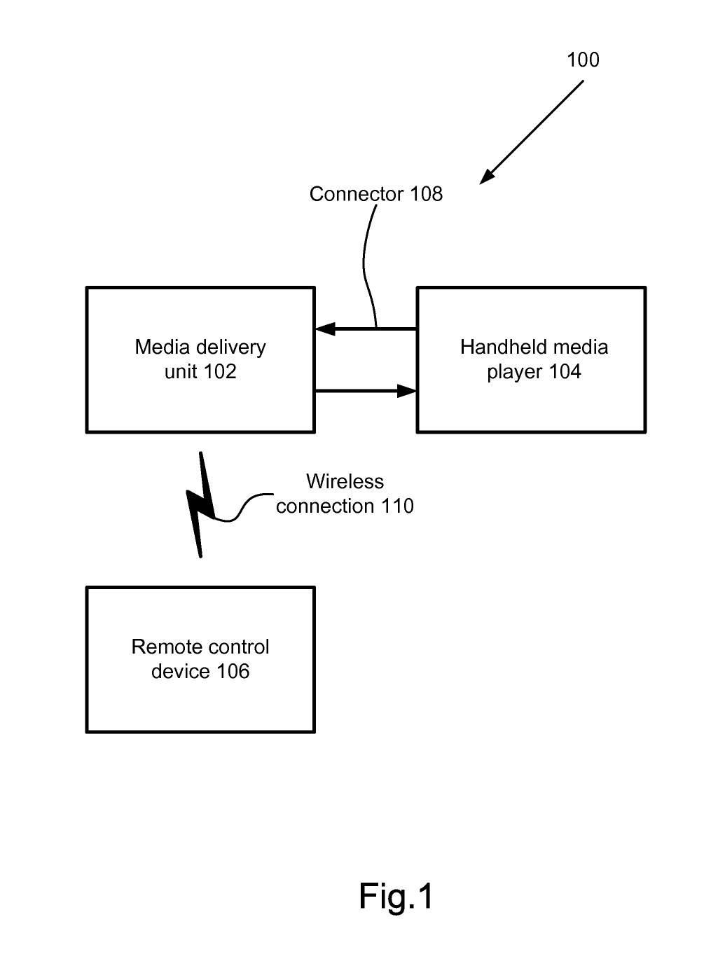

FIG. 1 shows a schematic diagram of a media delivery system based on the present invention. The system 100 includes a media delivery unit 102 and a handheld media player 104. A remote control device 106 may be used to control the operation of the system 100. The media delivery unit 102 and the handheld media player 104 are connectable through a connector 108. The remote control device 106 may connected to the media delivery unit through a wireless connection 110. The data may be transferable between 102 and 104 under the control of 106. The media delivery unit may be a stand alone apparatus for delivering media assets.

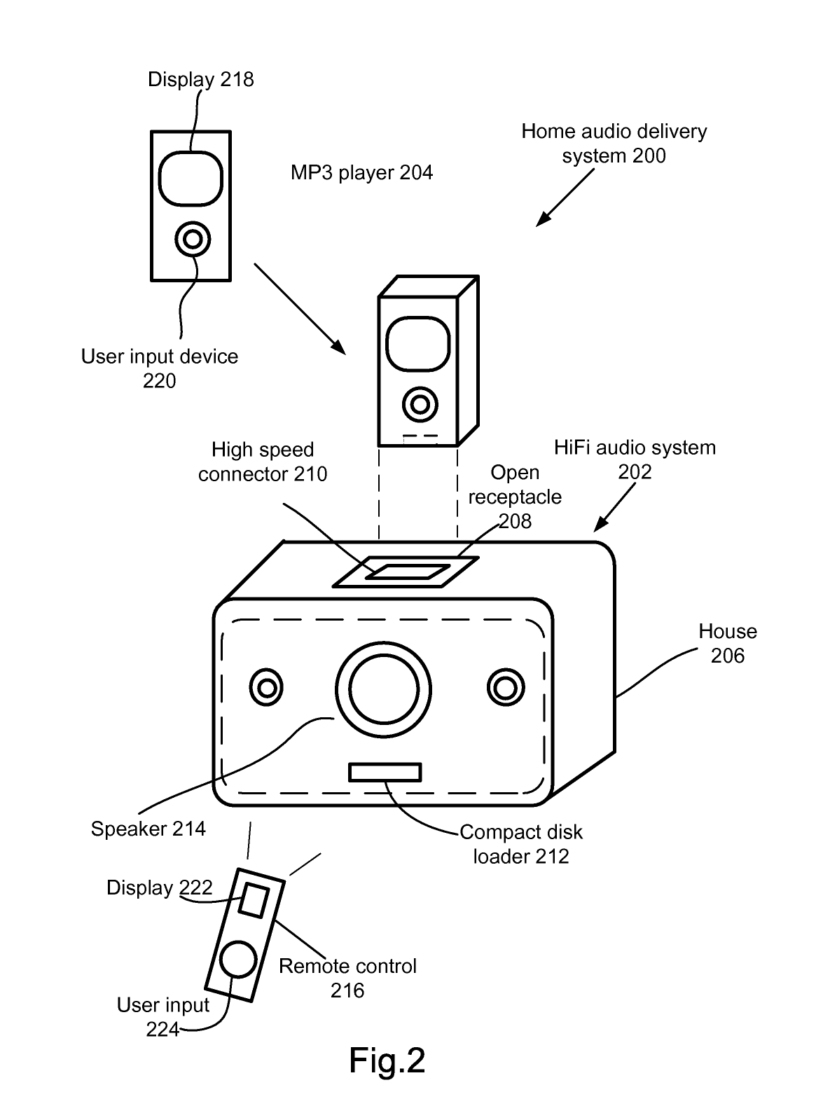

FIG. 2 shows a schematic diagram of one implementation of the media delivery system 100. As shown in the figure, a home audio delivery system 200 includes a HiFi audio system 202 and a MP3 player 204. The HiFi audio system 202 includes a house 206, an opening or receptacle 208, a high speed connector 210, a compact disk loader 212 and speakers 214. It further includes an exemplary remote control device 216. The MP3 player 204 includes a display such as a Liquid Crystal Display (LCD) 218 and a user input device 220 such as a rotational user interface used in some models of the iPod from Apple Inc. The remote control device 216 includes a display 222 (e.g., LCD) and a user input device 224 (i.e. keys, buttons or touch-pads etc). The HiFi audio system 202 and the handheld media player 204 can be connected through the connector 210, which may be a FIREWIRE (IEEE 1394 type of connection) or a USB (Universal Serial Bus) type of connection. In the prior art by Hobson et al in US patent publication 2007/0230723, a method to connect a handheld media player and a media delivery unit such as the HiFi audio system has been disclosed in detail.

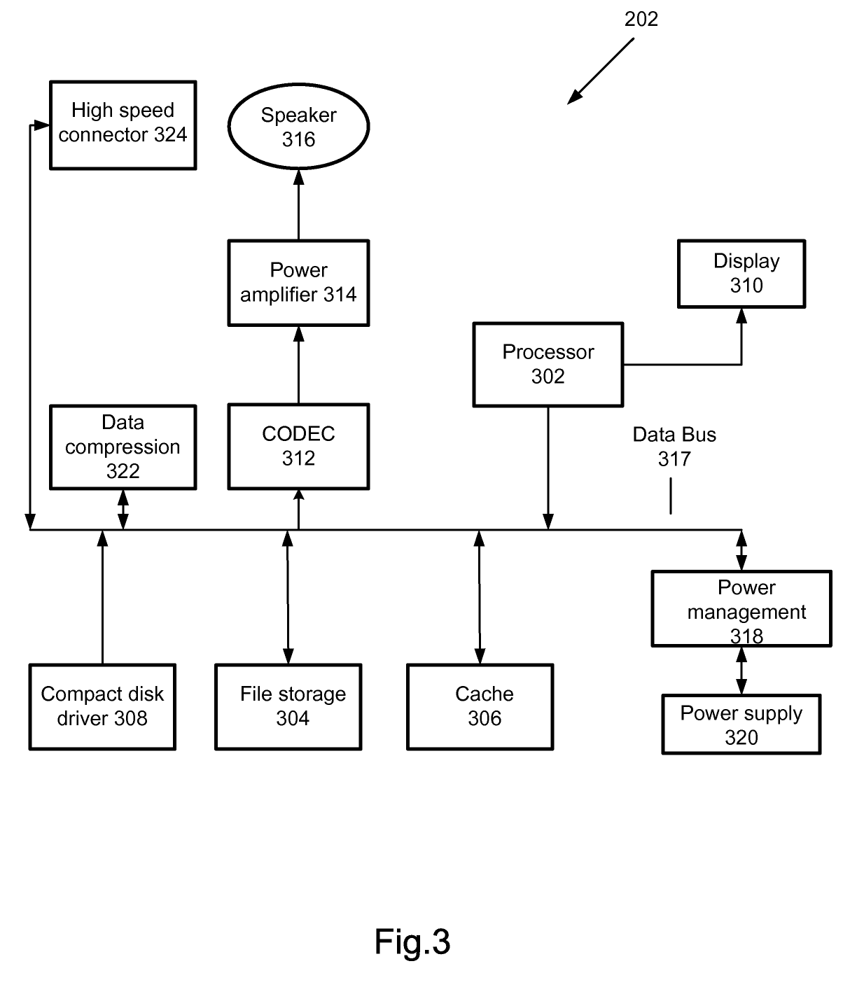

FIG. 3 is a schematic functional block of the HiFi audio system 202. The HiFi system 202 includes a processor 302 that pertains to a microprocessor or a controller for controlling the overall operation of the system. In accordance with one implementation of the present invention, the HiFi system 202 includes a file storage system 304 and a cache 306 for storing audio data files. The file storage system 304 is, typically, a flash memory or a plurality of flash memories or a magnetic disk driver or a plurality of magnetic disk drivers. The file storage system 304 typically provides high capacity storage capability for the HiFi system 202. However, since the access speed to the file storage system 304 is relatively slow, the HiFi system 202 can also include a cache 306. The cache 306 is, for example, Random-Access Memory (RAM) provided by semiconductor memory. The relative access time to the cache 306 is substantially shorter than for the file system 304. However, the cache 306 does not have the large storage capacity of the file system 304. As shown in the figure, the HiFi system 202 includes a compact disk driver 308, which reads out the media asset such as a song or a music clip from the compact disk and converts the assets into digital signals.

The HiFi system 202 further includes a display 310 (e.g., LCD) that can be controlled by the processor 302 to display information to the user. When a user desires to have the HiFi system 202 to deliver (play) a particular media asset such a song from a loaded compact disk, the user can select one of the available audio files by using of the remote control 216. The processor 302, upon receiving a selection of a particular media asset, supplies the media data (e.g., audio file) for the particular media item to a coder/decoder (CODEC) 312. The CODEC 312 then produces analog output signals for a high precision power amplifier 314 and speakers 316.

A data bus 317 can facilitate data transfer between at least the file system 304, the cache 306, the processor 302, and the CODEC 312. The HiFi system 202 is powered by a power supply 320 through power management circuits 318.

According to one implementation of the present invention, the HiFi system 202 further includes a data compression unit 322 and a high speed interface (connector) 324. When a high fidelity audio file is being delivered, the file is compressed to a desired format such as MP3. The compressed audio data may be stored in the cache 306 for transferring to the connected MP3 player 204 or be stored in the file storage system 304. The compressed audio files stored in the file storage system 304 may also be transferred to the connected MP3 player 204 in a late time. The high speed interface 324 may be the FIREWIE (IEEE 1394 type of connection) or the USB type of connection.

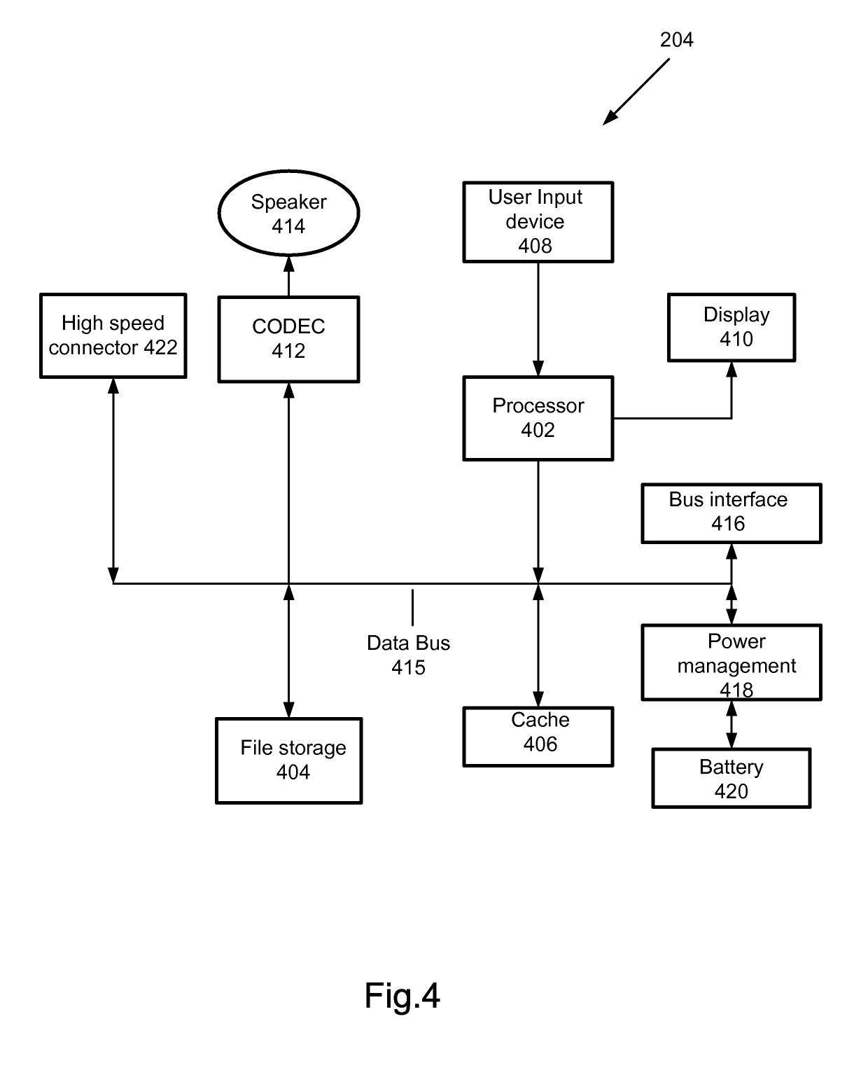

FIG. 4 shows a schematic functional block of a MP3 player 204. The MP3 player 204 includes a processor 402 that pertains to a microprocessor or a controller for controlling the overall operation of the media player. The MP3 player 204 stores media data pertaining to audio assets in a file storage system 404 and a cache 406. The file system 404 is, typically, a flash memory or a plurality of flash memories or a magnetic disk drivers or a plurality of magnetic disk drivers. The file system 404 typically provides high capacity storage capability for the MP3 player 204. However, since the access speed to the file system 404 is relatively slow, the MP3 player 204 can also include a cache 406. The cache 406 is, for example, Random-Access Memory (RAM) provided by semiconductor memory. The relative access time to the cache 406 is substantially shorter than for the file system 404. However, the cache 406 does not have the large storage capacity of the file system 404. Further, the file system 404, when active, consumes more power than does the cache 406. The power consumption is particularly important for the MP3 player 204 that is powered by a battery 420 through power management circuits 418. The MP3 player 204 may also include a RAM and a Read-Only Memory (ROM), which is not shown in the diagram. The ROM can store programs, utilities or processes to be executed in a non-volatile manner. The RAM provides volatile data storage, such as for the cache 406.

The MP3 player 204 also includes a user input device 408 that allows a user of the MP3 player 204 to interact with the player. For example, the user input device 408 can take a variety of forms, such as a button, keypad, dial, etc. Still further, the MP3 player 204 includes a display 410 (e.g., LCD) that can be controlled by the processor 402 to display information to the user.

The MP3 player 204 serves to store many media assets (e.g., songs) in the file storage system 404. When a user desires to have the MP3 player 204 to play a particular media asset, a list of available media assets is displayed on the display 410. Then, using the user input device 408, a user can select one of the available media assets. The processor 402, upon receiving a selection of a particular media item, supplies the media data (e.g., audio file) for the particular media asset to a coder/decoder (CODEC) 412. The CODEC 412 then produces analog output signals for speakers 414. A data bus 415 can facilitate data transfer between at least the file storage system 404, the cache 406, the processor 402, and the CODEC 412. The MP3 player 204 also includes a bus interface 416 that couples to a data link (not shown). The data link allows the MP3 player 204 to couple to a host computer or to the HiFi system 202. The MP3 player 204 is powered by a power supply 420 through power management circuits 418.

The MP3 player 204 further includes a high speed interface (connector) 422. The interface may conform to a FIREWIRE (IEEE 1394 type of connection) or a USB type of connection. When the MP3 player 204 and the HiFi system 202 are connected, the audio files can be transferred through the high speed interfaces 324/422.

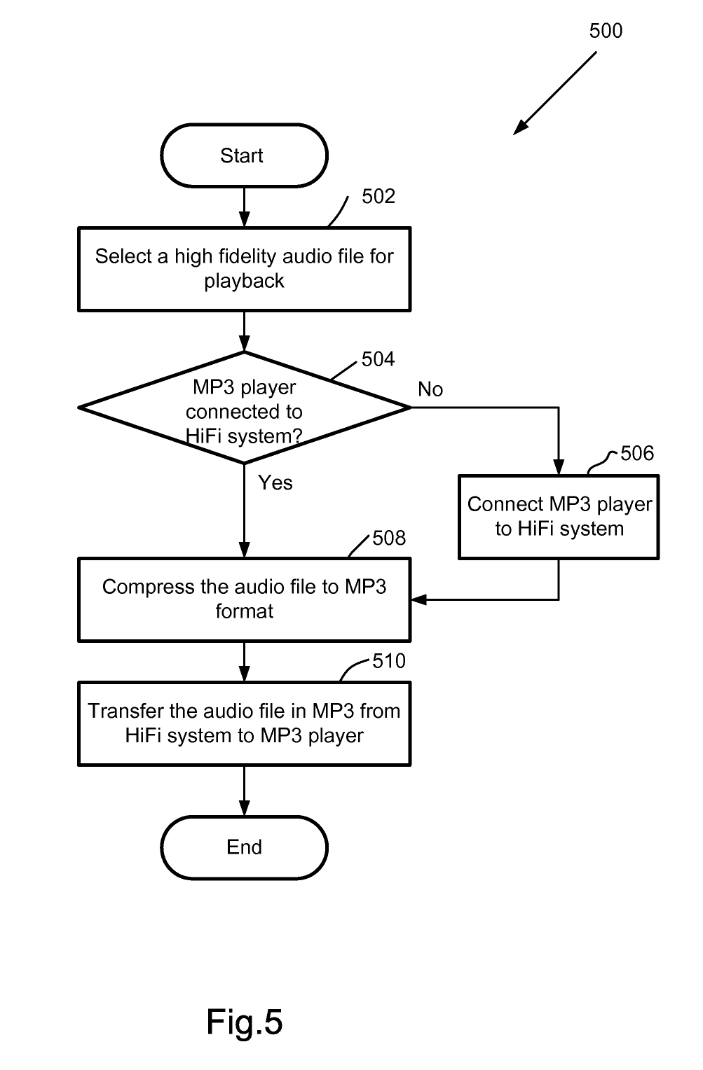

FIG. 5 shows a flow diagram of a process 500 that a high fidelity audio file is compressed and is transferred to the MP3 player 204 while the audio file in a high fidelity format is being played by the HiFi system 202. Process 500 begins with a step 502 that an audio file is selected for playback. Step 504 checks if the MP3 player 204 has been connected through the high speed interfaces 324/422. If the result is negative, the MP3 player 204 is connected to the HiFi system 202 in step 506. The audio file is compressed to a desired format such as MP3 in step 508 and the compressed audio file is transferred to the MP3 player in step 510. The operation is controlled by the processor 302 of the HiFi system 202. The MP3 player 204 receives the audio file and stores the file in its file storage system 404. The remote control device 216 may be used to activate the operation of the compression and/or the operation of the transferring of the audio data under the control of a user.

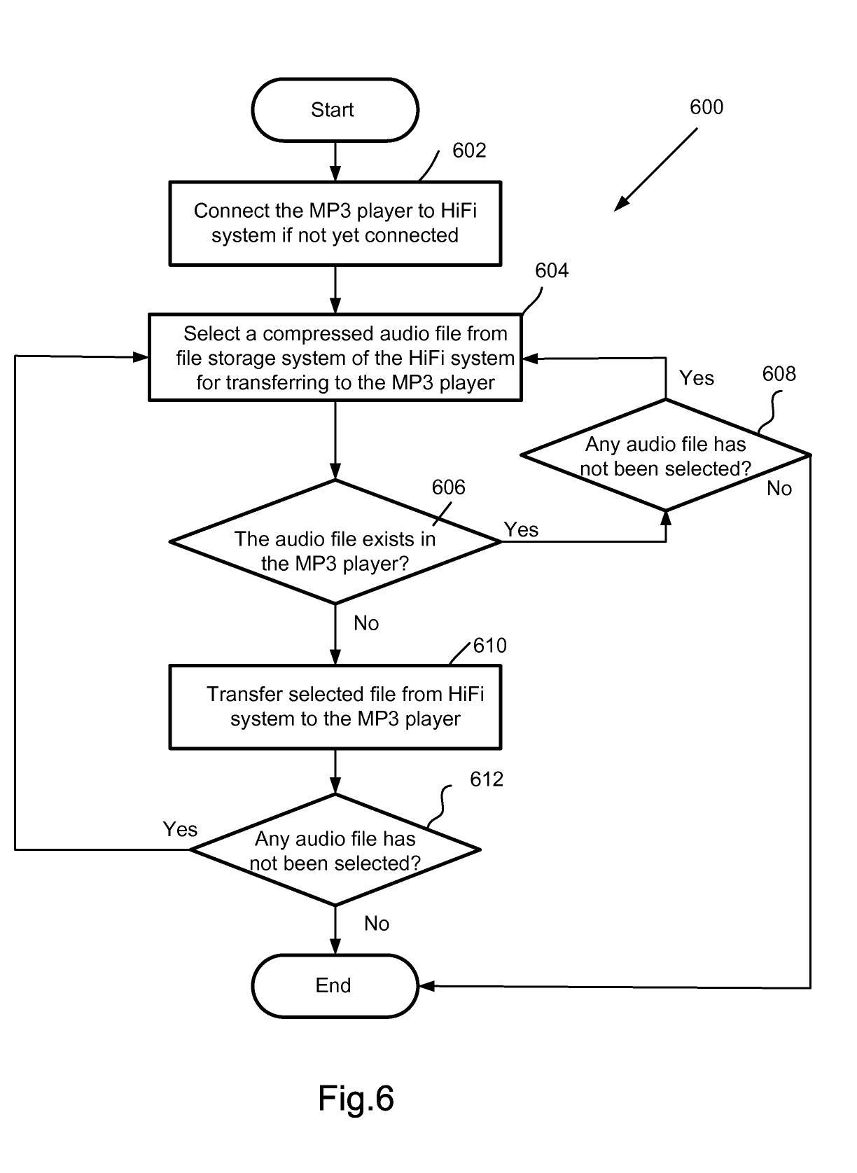

FIG. 6 shows a flow diagram of a process 600 that compressed media assets stored in the file storage system 304 of the HiFi system 202 are transferred to the MP3 player 204 when they are connected. Process 600 begins with step 602 by connecting the MP3 player 204 to the HiFi system 202 if they have not been connected. A compressed audio file in a format of MP3 is then selected in step 604 for transferring. The processor 302 of the HiFi system 202 checks if the file has already been stored in the file storage system 404 of the MP3 player 204 in step 606. The operation can be carried out by sending a metadata of the associated audio file from the HiFi system 202 to the MP3 player 204 through the high speed interfaces 324/422. The processor 402 in the MP3 player 204 receives the metadata and compares with the existing audio files in its file storage system 404. The processor 402 in MP3 player 204 sends back a signal to the HiFi system 202 indicating if the file has been stored in the MP3 player 204. If the file has already been stored in the MP3 player 204, the processor 302 in the HiFi system 202 skips the file and selects another compressed file in step 608. The selected audio file which does not exist in MP3 player 204 is transferred in step 610. The processor 402 checks if any file in the file storage system 305 has not been selected in step 612. The steps 604 to 612 are repeated till all audio files in the file storage system 304 of the HiFi system 202 are selected and transferred accordingly.

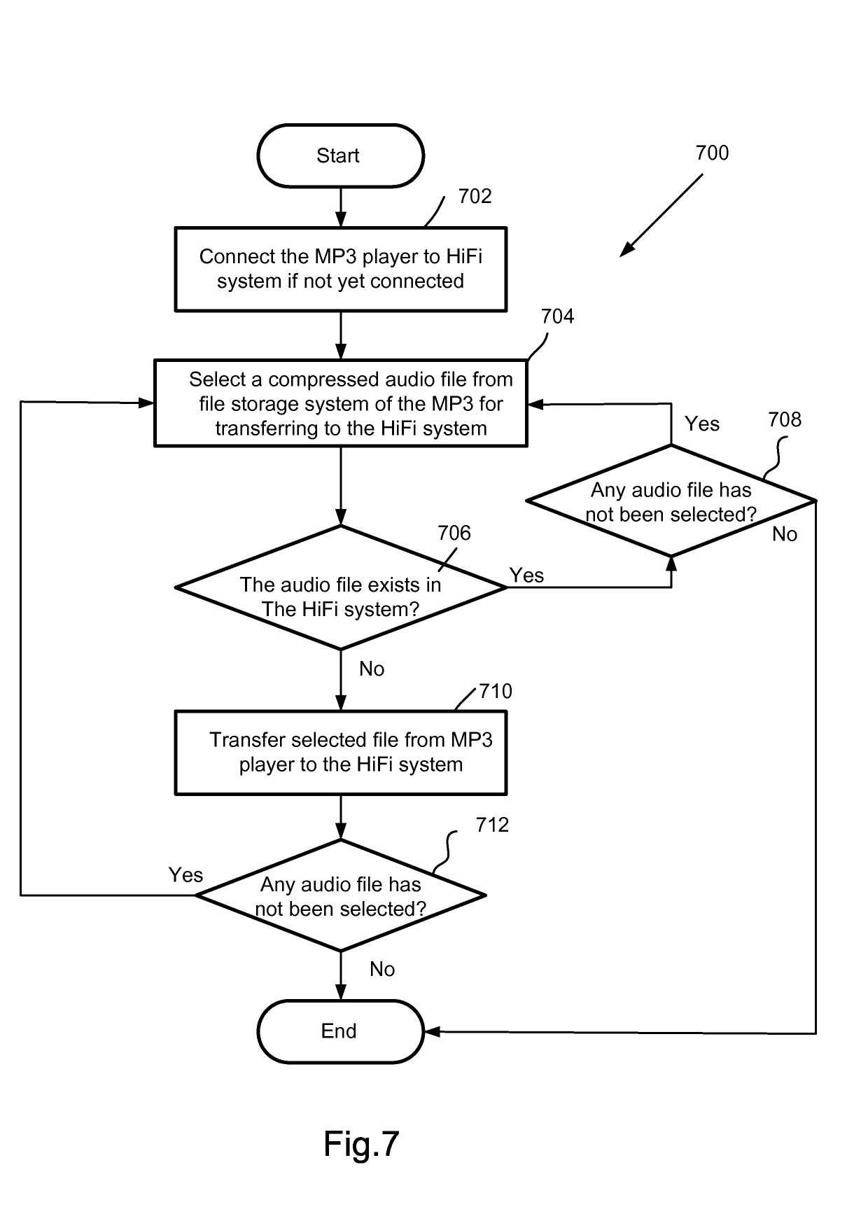

FIG. 7 shows a flow diagram of a process 700 that compressed media assets are transferred from the MP3 player 204 to the file storage system 304 of the HiFi system 202. Process 700 begins with step 702 by connecting the MP3 player 204 to the HiFi system 202. A compressed audio file in MP3 format is then selected in step 704 for transferring from the MP3 player 204 to the HiFi system 202. The processor 402 in the MP3 player 204 checks if the file has already been stored in the file system 304 of the HiFi system 202 in step 706. The method is similar to the one described previously. If the file has already been stored in the HiFi system 202, the processor 402 of the MP3 player 204 skips the file and selects another compressed audio file in step 708. The selected audio file which does not exist in the HiFi system 202 is transferred in step 710. The processor 402 checks if any file in the file storage system 404 has not been selected in step 712. The steps 704 to 712 are repeated till all audio files in the file storage system 404 of the MP3 player 204 are selected and transferred accordingly.

It should be noted that the processes 600 and 700 for files transferring between the HiFi system 202 and the MP3 player 204 are exemplary. Numerous other methods may be implemented based on the similar inventive concept. In another implementation, all metadata of the compressed media files may be transferred from HiFi system 202 to the MP3 player 204. The processor 402 in MP3 player 204 then compares the received metadata and sends back a file to the HiFi system 202 indicating a list of audio files which are not stored in the MP3 player 204. The processor 302 of the HiFi system 202 then controls an operation of transferring all listed audio files to the MP3 player 204. Similarly, the audio files can be transferred from the MP3 player 204 to the HiFi system 202.

In yet another implementation, all audio files are transferred from HiFi system 202 to the MP3 player 204 at first. The files, which have already been stored in the MP3 player 204, are removed under the control of the processor 402 of the MP3 player 204. The method can also be applied to the transfer of the audio files from the MP3 player 204 to the HiFi system 202.

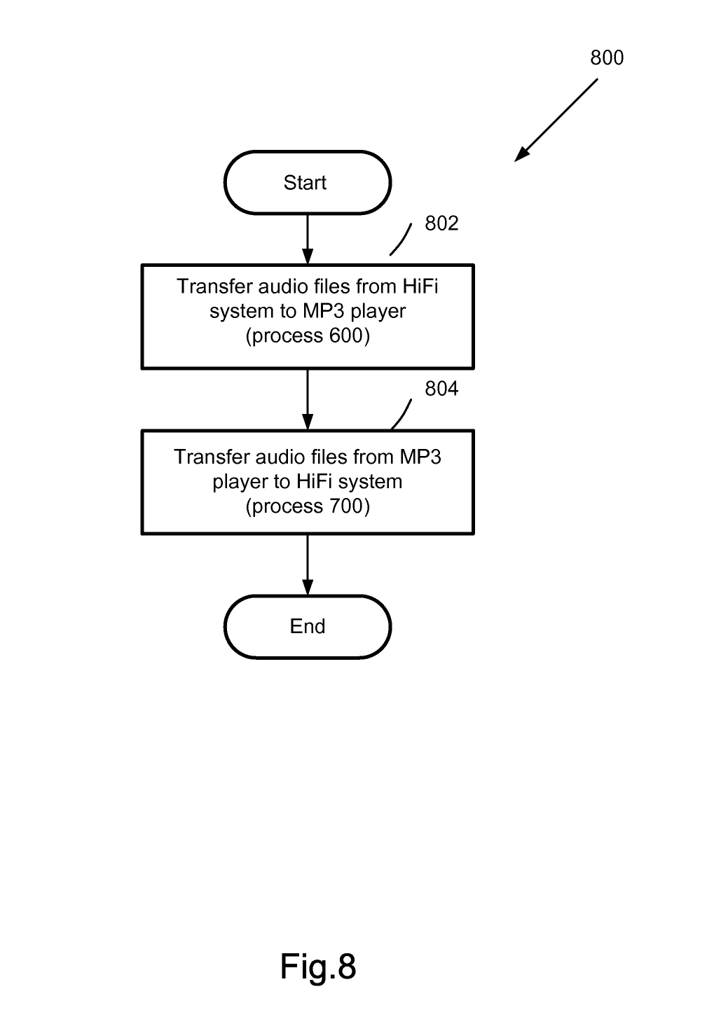

FIG. 8 shows a flow diagram of a process 800 that compressed audio files are transferred in between the HiFi system 202 and the MP3 player 204 to synchronize two databases of the file storage systems 304 and 404. The process is a combination of the process 600 and the process 700. Although the flow diagram indicates that step 802 for transferring audio files from the HiFi system 202 to the MP3 player 204 is ahead of the step 804 for transferring audio files from MP3 player 204 to the HiFi system 202, the sequence is swappable. Furthermore, in some implementations, step 802 and step 804 may be carried out in parallel.

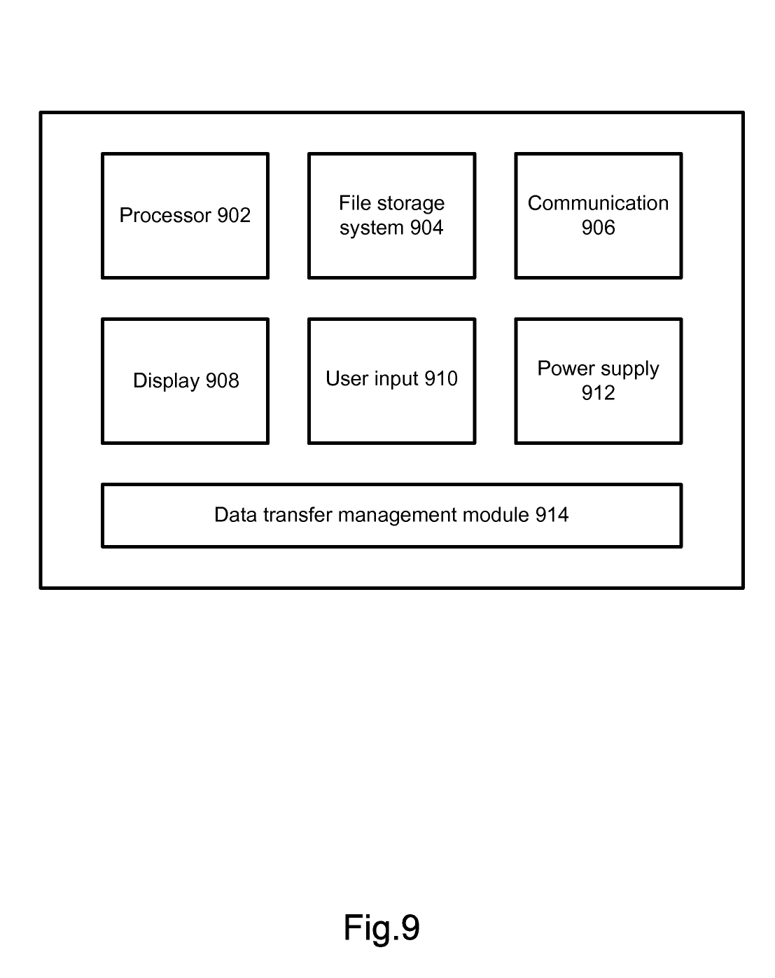

One of the innovative features of the present invention is that the data transfer between the HiFi system 202 and the MP3 player 204 may be controlled by the remote control device 216. As shown in FIG. 9, an exemplary remote control device 900 includes a processor 902 that pertains to a microprocessor or a controller to control the operation of the device, a file storage system 904 for storing data, a communication unit 906 for communicating with the HiFi system 202, a display 908 (e.g., LCD), a user input device 910 and a power supply such as a battery 912. The remote control device 900 further includes a data transfer management module 914. The data transfer management module 914 is a software module to control the operation that a user selects a mode of the data transfer between the HiFi system 202 and the MP3 player 204.

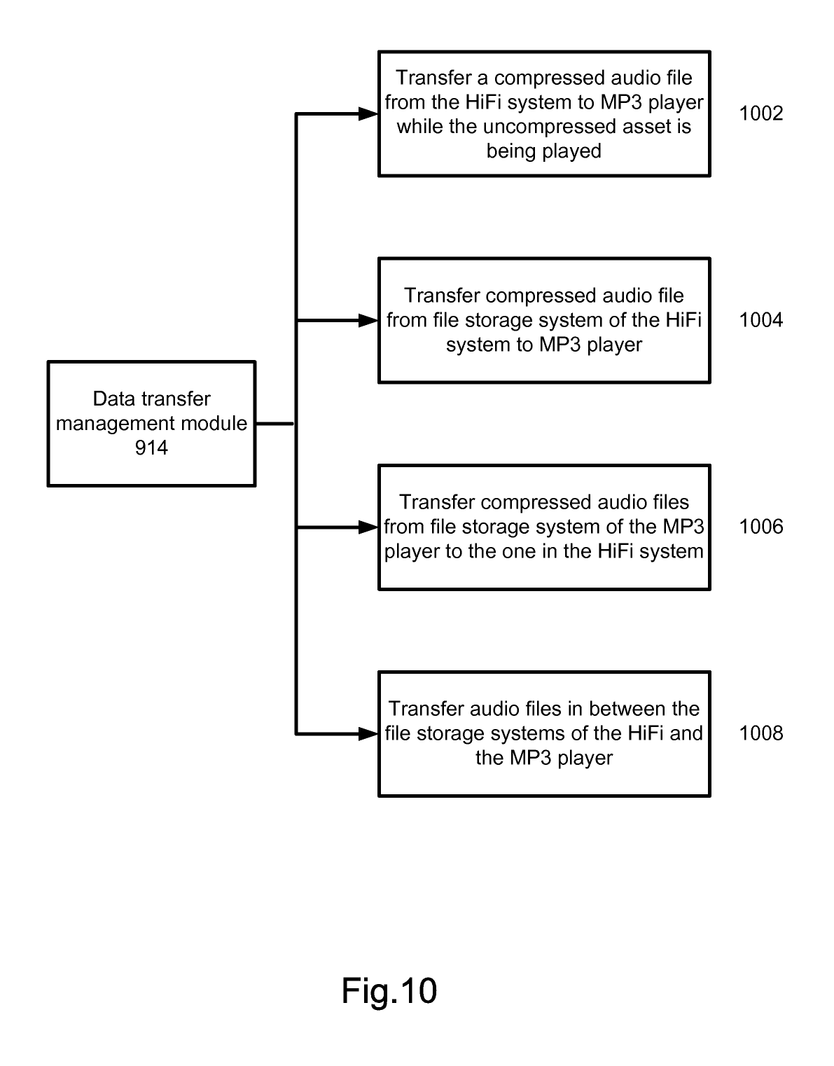

In an exemplary implementation of the present invention, the data transfer management module 914 may select a transfer mode from four user selectable modes as shown in FIG. 10. 1002 is a mode representing the process 500 that an audio file is compressed and is transferred from the HiFi system 202 to the MP3 player 204. 1004 is a mode representing the process 600 that compressed audio files stored in the file storage system 304 are transferred from the HiFi system 202 to the MP3 player 204. 1006 is a mode representing the process 700 that compressed audio files stored in the file storage system 404 are transferred from the MP3 player 204 to the HiFi system 202. 1008 is a mode representing the process 800 that audio files are transferred in between the HiFi system 202 and the handheld the MP3 player 204 and two databases for compressed audio file are synchronized.

While the invention has been disclosed with respect to a limited number of embodiments, numerous modifications and variations will be appreciated by those skilled in the art. The audio assets have been used as the exemplary cases in the disclosure. The inventive concept can be extended to video or multi-media files for one skillful in the art. The home high fidelity audio system has been used to illustrate the inventive concept. It, however, can be extended to other media delivery units such as vehicle media systems. It is intended that all such variations and modifications fall within the scope of the following claims:

1. A method of transferring media assets between a media delivery unit and a handheld media player, the method comprising:
delivering a media asset by the media delivery unit;
compressing the media asset being delivered to a desired format by the media delivery unit; and
transferring the compressed media asset to the handheld media player.

2. The method as recited in claim 1, wherein the method further comprising:
storing the compressed media asset into a file storage system of the media delivery unit; and
triggering the operation of “transferring” by sending an instruction through a remote control device.

3. The method as recited in claim 1, wherein the media delivery unit and the handheld media player are connected through a connector including the following types of connection:
a FIREWIRE (IEEE 1394); and
a USB (Universal Serial Bus).

4. The method as recited in claim 1, wherein the method further comprising transferring media assets from the handheld media player to the media delivery unit.

5. The method as recited in claim 1, wherein the media delivery unit includes a high fidelity audio system.

6. A system including a media delivery unit, a remote control device and a handheld media player, wherein the system providing user selectable options for transferring media assets between the unit and the player under control of the remote control device.

7. The system as recited in claim 6, wherein the media delivery unit and the handheld media player are connectable through a connector; and the remote control device and media delivery unit are connectable through a wireless means.

8. The user-selectable options as recited in claim 6, further including:
a) transferring a media asset in a compressed format from the media delivery unit to the handheld media player while the asset in an un-compressed format is being delivered;
b) transferring compressed media assets stored in a file storage system of the media delivery unit to the handheld media player;
c) transferring media assets stored in a file storage system of the handheld media player to the media delivery unit; and
d) any combination of a), b) and c).

9. The media delivery unit as recited in claim 6 further comprises:
a media playback device;
a data compression unit;
a file storage system; and
a connector for connecting with the handheld media player.

10. The data compression unit as recited in claim 9 provides means for converting a media asset into a compressed format including MP3 (Motion Picture Expert's Group Layer 3).

11. The media playback device as recited in claim 9 includes a high fidelity audio system.

12. The handheld media player as recited in claim 9 includes a MP3 player.

13. The file storage system as recited in claim 9, further comprising:
one or a plurality of semiconductor memories; and/or
one or a plurality of magnetic disk drivers.

14. The connector as recited in claim 7, further including the following types of connection:
a FIREWIRE (IEEE 1394); and
a USB (Universal Serial Bus).

15. A method of controlling media asset transfer, by employing a remote control device, between a media delivery unit and a handheld media player connected through a connector, the method comprising:
receiving a user's selection of a mode of data transferring from a plurality of modes by the remote control device;
sending the instruction associated with the selected mode from the remote control device to a processor of the media delivery unit; and
executing data transfer between the media delivery unit and the handheld media player based upon the received instruction.

16. The method as recited in claim 15, wherein the method further comprising receiving a user instruction from the remote control device by the media delivery unit to compress a media asset to a desired format while the asset is being delivered by the unit.

17. The method as recited in claim 15, wherein said modes of data transferring including:
a) transferring a media asset in a compressed format from the media delivery unit to the handheld media player while the asset in a un-compressed format is being delivered;
b) transferring compressed media assets stored in a file storage system of the media delivery unit to the handheld media player;
c) transferring media assets stored in a file storage system of the handheld media player to the media delivery unit; and
d) any combination of a), b) and c).

18. The method as recited in claim 15, wherein the media delivery unit is a high fidelity audio system.

19. The method as recited in claim 18, wherein the high fidelity audio system including a data compression unit and a file storage system.

20. The method as recited in claim 15, wherein the connector including the following types of the connection:
a FIREWIRE (IEEE 1394); and
a USB (Universal Serial Bus).
